(19) United States
(12) Patent Application Publication
(10) Pub. No.: US 2004/0055292 A1
(43) Pub. Date: Mar. 25, 2004

(54) AlphaCor alpha powered miniaturized power plant

(76) Inventor: Claudio Filipppone, College Park, MD (US)

Correspondence Address: CLAUDIO FILIPPONE, 8708 48th PLACE, COLLEGE PARK, MD, 20740, US

(21) Appl. No.: 10/247,480

(22) Filed: Sep. 20, 2002

(51) Int. Cl. F01B 1/00; F01K 1/00; F02B 1/00

(52) U.S. Cl. 60/508; 60/514

(57) ABSTRACT

The proposed device is a self-powered blood pumping system whose source of energy is extracted from a radioisotope emitting alpha particles and can be used in place of natural hearts. An autonomous miniaturized symmetrical and redundant nuclear-thermodynamic power plant is integrated inside a totally artificial heart formed by a double piston-cylinder assembly able to transform the heat generated by alpha emitting isotopes into mechanical energy to pump blood without need for “extra-body” power sources. The source of heat is constituted by alpha decaying isotopes (i.e. Curium, Plutonium, Polonium, etc.), contained inside specially designed miniaturized decay heat alpha cartridges able to provide superheated vapor. This device can operate independently of external power sources for extended time duration from several months up to several years depending on which isotope is used in the cartridge. The overall blood pumping system closely imitates the behavior of the human heart by providing a pulsatile flow of blood with the same pressure variations encountered in the human cardiovascular system.

### BACKGROUND AND PRIOR ART

Since the introduction of cyclosporine, an immunosuppressant, mechanical circulatory support has been used in high-risk patients awaiting for heart transplantation. The concept of using a mechanical device to support human heart dates back to the early 1800s. The first clinical application of cardiopulmonary bypass to allow intracardiac repair was successfully achieved in 1953. However, the first successful implantable mechanical assist device occurred in 1963 by Dr. Michael E. DeBakey, who implanted a pulsatile, air-driven, ventricular assist device in a patient in high-risk conditions after an aortic valve operation. Since then various Total Artificial Heart (TAH) with different mechanical characteristics were developed and implanted.

Long term mechanical assist devices are designed to sustain patients with irreversible cardiac dysfunction until the natural heart can be replaced with a transplant. Normally, these devices are designed to work in parallel with the diseased natural heart for weeks, months, and years. TAH, which can be implanted or remain outside the body, are designed to replace the natural heart and are not approved for clinical use in the United States. Currently there are three different types of TAH devices used to support patients in need of long-term mechanical assistance: The Thoratec Ventricular Assist System (VAS), the Novacor Left Ventricular Assist System (LVAS), and the HeartMate LVAS. The Thoratec is an extracorporeal system and patients with this device have limited mobility. The Novacor device operates on external batteries, and again, patients with this device have a limited mobility. The HeartMate device is an implantable pneumatic or electric device which also needs an external source of power with a consequent limited mobility of the patient. The most common TAH devices are pneumatically actuated and utilize diaphragm-type ventricles to substitute the natural ventricles. Other TAH devices utilize electrical motors which, to a certain extent, cause severe blood damage (hemolysis). In all cases, all of the devices developed so far, implantable or extracorporeal, must rely on an external source of power which forces cables, tubes or both to cross the skin barrier of the patient, thereby significantly increasing the probability of lethal infections.

Normally, long-term mechanical assistance is used in patients awaiting cardiac transplantation; however, the proposed AlphaCor is totally implantable (no need for tubes, electric wires, or any other connection outside the body of the patient), and may be used as an alternative to transplantation. In general, most available long-term circulatory support systems have to be hydraulically and electrically connected with an extra-body source of energy (batteries and/or air/fluid pneumatic systems). Therefore, the probability of infection and subsequent death of the patient is still very high. Even if the most advanced currently available TAH does not pierce the skin barrier of the patient it still relies on an electric power source. This source in normally provided by batteries with a relatively short availability of power, thereby forcing the patient to be connected to a power supply severely impacting his/her mobility.

Since the source of power of the AlphaCor is nuclear decay heat able to provide the required pumping power for several years, it does not need external electrical or hydraulic connections. This minimizes the probability of infection, and allows the patient to conduct a pseudo normal life (no need to be connected to a power source). AlphaCor allows the patient to travel, and perform every kind of activity as if his/her heart was a regular human heart.

A comparison with the available long-term circulatory support systems provided by: Throtatec VAS (Thoratec Corporation, Berkley, Calif.), Novacor (Baxter, Healthcare Corporation, Oakland, Ca), HeartMate, Abiomed, and Implantable Pneumatic Left Ventricular Assisted Systems, shows that AlphaCor is the first total artificial heart that does not require external connections to a power supply. Even the most advanced total artificial heart designed and commercialized, by Abiomed utilizes a power supply powered by electric batteries.

Since alpha particles are easily shielded by the outer shell encasing the blood pumping device of AlphaCor the yearly radiation dose emitted by the alpha heating elements of AlphaCor is minimum. In fact, depending on the isotope utilized the radiation dose rate absorbed by a patient with an AlphaCor implant is equivalent to approximately three-four conventional chest x-ray in a year.

AlphaCor may provide a constant rate heart beat, or it can increase/decrease its pumping rate by sampling the concentration of key chemicals in the blood stream. AlphaCor can also increase or decrease its pulsing “beat” by monitoring the rate of respiration through detectors sampling the pressure changes in the lungs and the frequency of such changes.

The present invention relates to a pumping mechanism in which the heat released by the emission of radio-isotopes is utilized as the source of power. More specifically it relates to a highly efficient miniaturized thermodynamic engine capable of producing shaft work as a result of the expansion of a fluid inside a miniaturized positive displacement expansion/contraction system which drives a pumping device for mechanical circulatory support.

Therefore, an objective of the proposed invention is to provide a special miniaturized nuclear power plant (alpha-powered), mechanically connected to the positive displacement blood pumping device which forms, in its whole, a closed, and self-sustained, thermodynamic cycle. In this miniaturized power plant the condensation of the fluid utilized for the expansion and contraction of the positive displacement blood pumping device is achieved by the “cooling” action of the blood itself. The blood is the coolant of the thermodynamic engine and the body of the patient becomes the “radiator” for condensation of the fluid utilized in this cycle. In this manner the alpha powered TAH device is implantable with no need for extra body electrical or hydraulic connections. AlphaCor, or this alpha-powered TAH significantly decreases the probability of lethal infections, while at the same time increases the reliability of the system (lower probability of electric wires or tube disconnection/breakdown as in conventional TAH). Most importantly AlphaCor allows unlimited mobility of the patient/s who can conduct a quasi-normal life.

### SUMMARY OF THE INVENTION

An objective of the present invention is to provide an apparatus, and a method of autonomously producing power to be utilized as a propulsion system to pump blood at fixed or variable mass flow rates by utilizing the decay heat of selected radioisotopes. It is a further object of the invention to provide an apparatus for generating a pulsatile flow of blood, which mimics as closely as possible the behavior of the human heart. AlphaCor is able to substitute diseased human hearts for several years without needing external sources of power. Finally, a comprehensive objective of this invention is to provide a miniaturized power plant able to generate mechanical or electrical energy to be utilized by other TAH or by all applications requiring a miniaturized generalized power source able to deliver power for prolonged amounts of time without need for refueling or recharging batteries. In this invention a variety of apparatus combined together provide different methods of collecting the thermodynamic energy/heat released by the radioisotope decay and transform it into usable energy (i.e. mechanical, electrical). Also included in this invention is a positive displacement pumping mechanism utilizing valves mechanically controlled by the motion of the various components of the thermodynamic engine, as well as valves driven by the fluid dynamic effect of the circulating blood. Blood is the cooling fluid of AlphaCor tandem thermodynamic cycle. AlphaCor power plant can be used simply to produce power to be delivered to different applications. In this case, blood is substituted with any cooling fluid.

AlphaCor includes at least two distinct piston-cylinder assemblies, designed to offer the minimum surface in physical contact with the blood by means of a stretchable element or flexible membrane. These piston-cylinder assemblies on one side, the “engine” side, form the expansion and contraction system of a tandem thermodynamic cycle, on the other side, the “blood” side, they form the right and left artificial ventricles. On the “blood” side the piston-cylinder assemblies are hydraulically connected and sealed to multiple check valve systems having the same functions of the tricuspid, mitral, pulmonary, and aortic valves. These valves are specially shaped so that they offer the minimum fluid dynamic friction to the flow of blood. The valves can be actuated by the viscous action of the flow of blood, or they can be mechanically actuated through cammes, mechanical links, and spring loaded rods. The “engine” side of the piston-cylinder assemblies are sealed and hydraulically connected to a system of valves mechanically linked between each other so as to execute a tandem-thermodynamic cycle where the expansion of one piston-cylinder assembly occurs simultaneously with the contraction of the other piston-cylinder assembly. Overall, the tandem thermodynamic cycle is formed by the timely execution of a series of thermodynamic processes or steps in which the same fluid starts from a sub-cooled liquid state inside the cold thermal reservoir and undergoes the following thermodynamic processes:

A—heating inside the alpha cartridges, pressure and temperature increase during this process;

B—expansion inside one of the piston-cylinder assembly, pressure and temperature decrease during this process—generation of a positive power stroke (upward, see FIG. 1, 5a and 5b);

C—simultaneous contraction inside the alternate piston-cylinder assembly, pressure drops close to a vacuum, and temperature decreases during this process—generation of a negative power stroke (downward, see FIG. 1, 5a, and 5b);

D—condensation inside the heat exchangers releasing the excess heat in said fluid into a cooling fluid (blood or any fluid for more generalized applications).

These processes A-B-C-D are in a closed loop and form a tandem thermodynamic cycle since the power stroke of one piston occurs simultaneously with a power stroke in the opposite direction of the other piston. The pistons are linked to a crankshaft-like system and are put in motion by the expansion and contraction of a fluid with low vapor pressure. Said crankshaft-like system is also connected to rods, gears, or by a spring-loaded camme system so that the movement of the pistons is timed with several thermodynamic processes occurring during each complete stroke. The energy necessary to generate the pumping strokes alternately inside one of the artificial ventricles is provided by the expansion of said fluid circulating inside a closed-loop heat transfer system, while in the corresponding other ventricle said fluid is contracted. Said contraction is caused by the cooling action of minute amounts of said fluid found in a sub-cooled thermodynamic state timely sprayed inside the “engine” side of the piston-cylinder assembly. Cooling for condensation of said fluid is provided by heat transferred from the fluid to the blood via heat transfer surfaces designed in such a way that the increased blood temperature is at his maximum approximately 1.5 Celsius. The “engine” of the AlphaCor TAH is essentially formed by the tandem action of two symmetrical thermodynamic engines operating in opposite phases. The alpha emitting radioisotopes can be manufactured in the shape of cylindrical pellets, forming compact cartridges, or can be deposited on proper surfaces (i.e. by lining the inner shell containing the pumping device) in a way that these surfaces become the heat exchanger. The alpha cartridges can be made in any geometry and the shell utilized to contain the cartridge acts also as an alpha radiation shield. The inner core of said alpha cartridges can be formed by one or more reinforced and sealed pellet containing a variable amount of alpha emitting isotope in the form of deposited film, powder, or high pressure gas. One preferential, but not limiting, shape of said alpha cartridges is formed by concentric cylinders separated by an annular gap with vanes so as to prolong the transit time of said fluid while it changes thermodynamic state from sub-cooled liquid to superheated vapor during its passage inside said alpha cartridges. Said fluid is never directly in contact with said inner core containing the pellets of said alpha cartridges. The thermal power generated by said pellets or inner core of said alpha cartridges is proportional to the amount of isotope they contain. Furthermore, the time duration of said thermal power depends also on the amount of isotope contained inside said alpha cartridges and the half-life of the selected isotope.

In general, said fluid is vaporized and generated by heat transferred from surfaces lined by or containing the alpha emitting radioisotopes forming said alpha cartridges. Therefore, said fluid is transformed into superheated vapor by pumping it at relatively high pressures via miniaturized positive displacement pumps inside or hydraulically connected to said vanes inside said annulus inside said alpha cartridges. The thermodynamic state of said fluid prior its compression into said alpha cartridge is sub-cooled liquid. While transiting inside said alpha cartridges said fluid becomes superheated vapor. Depending on the choice and quantity of the alpha-decaying radioisotope utilized, AlphaCor can provide pumping energy for only a few months or up to 14-20 years. To increase safety and reliability, AlphaCor tandem thermodynamic cycle formed by two independent symmetric hydraulic circuits is designed with redundant safety features so as to offer at least half pumping power in case of failure of one of the two circuits. As in the natural heart, the blood side of AlphaCor is formed by two ventricles, the left and right ventricles, each separated by a movable partition forming the piston. In essence, the partition (or piston) separates each ventricle into two variable volumes: the top left/right ventricle (blood side), and the bottom left/right ventricle (engine side). Once the vapor expands inside any of the bottom left/right ventricles it condenses by transferring heat indirectly, via heat exchangers, to the blood, thereby increasing slightly the blood temperature. From a thermodynamic viewpoint, the blood is the cold thermal reservoir forming the “condenser” of the two thermodynamic engines. Each stroke inside each piston-cylinder assembly forming the two ventricles displaces the proper volume of blood in a pulsatile manner at the desired peak pressure value. To minimize damages of the blood due to shear and collisions with artificial bio-surfaces a stretchable element or flexible membrane is positioned between the piston surface and the blood. The “heart beat” rate and consequent mass flow rate of blood circulating inside AlphaCor can be fixed, or it can vary as a function of one or multiple variables depending on the degree of accuracy desired. In general, AlphaCor can be equipped with sensors which dynamically change the pumping rate by sampling one or more of said variables. Said variables can be the respiratory rate, or specific chemicals in the blood, or a combination of these. The heart-beat can be varied by increasing/decreasing the mass flow rate of said fluid pumped inside the alpha cartridges, or by automatically exposing more/less heated surfaces to said fluid. In this manner more/less superheated vapor expands inside the bottom ventricles, thereby increasing/decreasing the reciprocating speed of said pistons. The movable pistons utilized in each ventricles are also equipped with rare earth magnets magnetically coupled to a magnetic core including coils for the generation of electric power to provide internal electric energy for said sensor and their controlling microchip. When the AlphaCor is utilized as a power source to deliver electric or mechanical power to other devices the dimensions of the rare earth magnet and their relative magnetic circuit are scaled up so that the blood pumping features (the blood side) of AlphaCor are minimized or eliminated, while AlphaCor power production capabilities (the engine side) are maximized.

Overall, the partition constituted by the pistons seals and thermally separates the hydraulic circuit formed by said fluid from the blood which is never in physical contact with said fluid circulating in the closed loop.

Furthermore, the outer shell of AlphaCor is thermally insulated by a vacuum chamber or jacket separating the hot surfaces of the thermodynamic circuit from the internal organs of the patient.

### BRIEF DESCRIPTION OF THE DRAWINGS

FIG. 1; is a schematic representation of the basic AlphaCor tandem thermodynamic cycle in accordance with the present invention.

FIG. 2a; is sectional view of the internal components of AlphaCor including the two symmetric engines, the flexible connectors to vena cava, pulmonary trunk, pulmonary artery, and aorta, the positive displacement pumps, and the fluid reservoir.

FIG. 2b; is a perspective view of the internal components of AlphaCor.

FIG. 2C; is a perspective view of a simplified AlphaCor where the action of the pistons is driven by a miniaturized turbine assembly.

FIG. 3; is a simplified computer model of the internal components of AplhaCor propulsion system showing also the effect of the motion of the pistons on the stretchable element or flexible membrane separating the surfaces of the piston from the blood.

FIG. 4; is a front view of the internal components of AlphaCor showing the positive displacement pumps submersed in the working fluid, the cold reservoir, the decay heat alpha cartridge, and the electric alternator for the production of electric energy.

FIGS. 5a and 5b; are schematics showing the sequence of valves opening/closing and forming the AlphaCor tandem-thermodynamic cycle.

FIG. 6; is a model of the AlphaCor external casing and shielding showing also the mechanical couplers accessible with a special tool.

### DESCRIPTION OF THE PREFERRED EMBODIMENTS

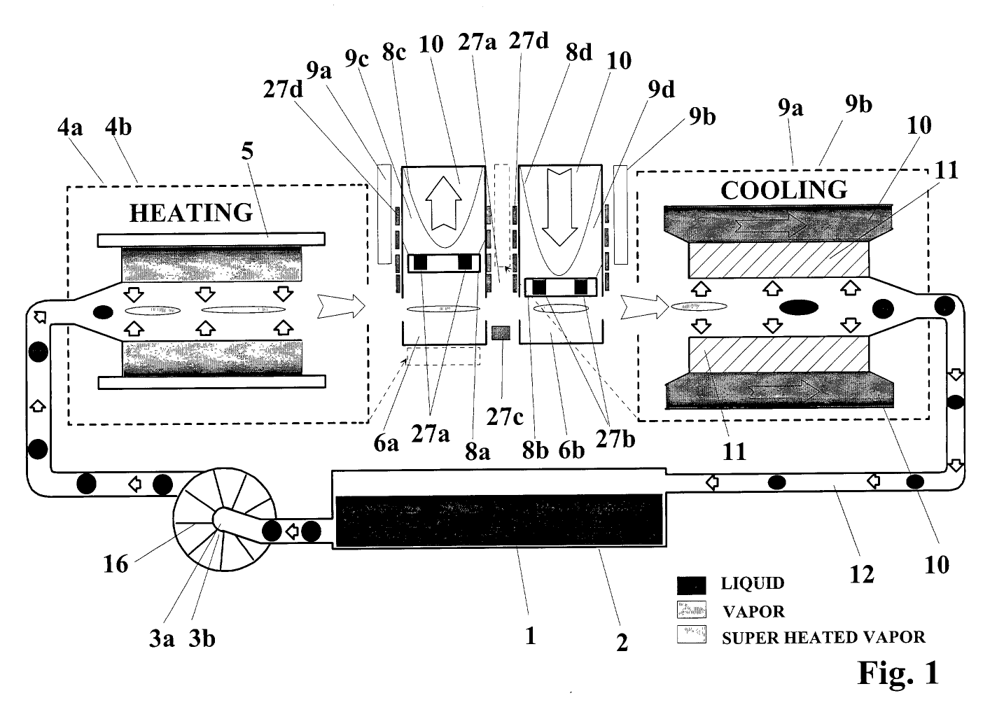

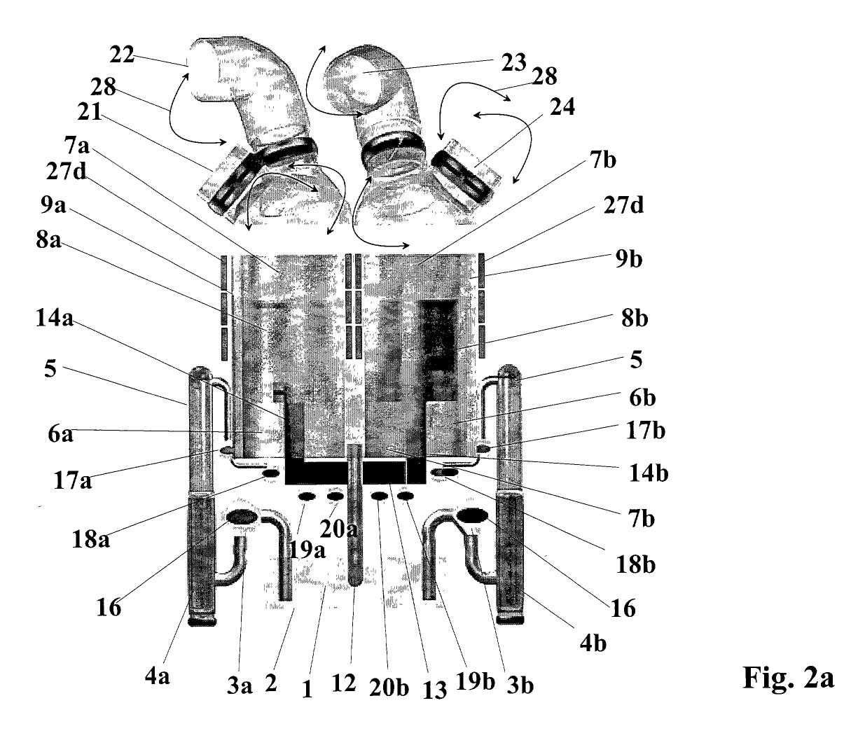

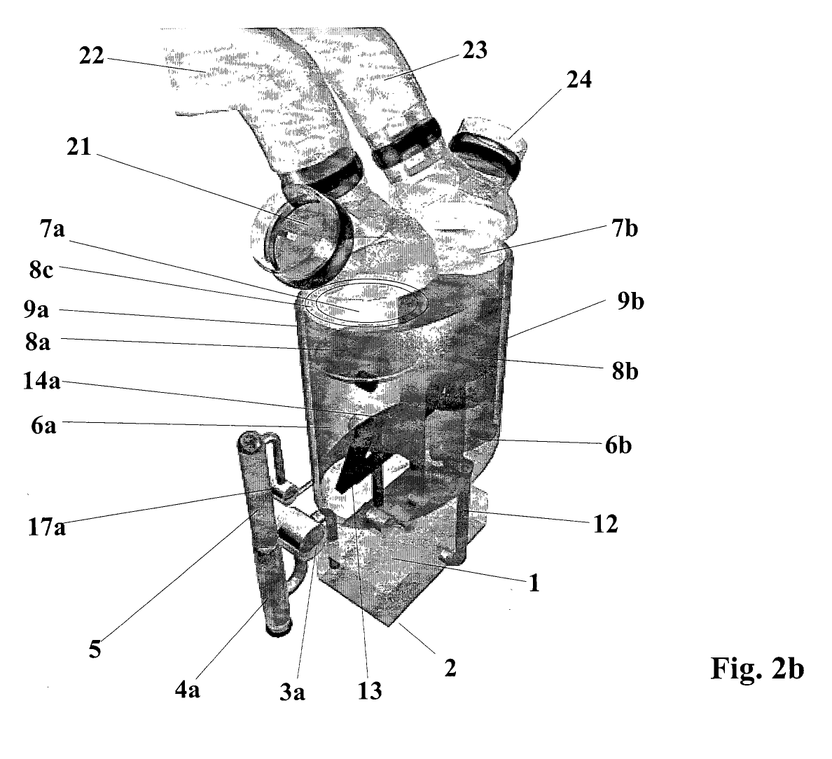

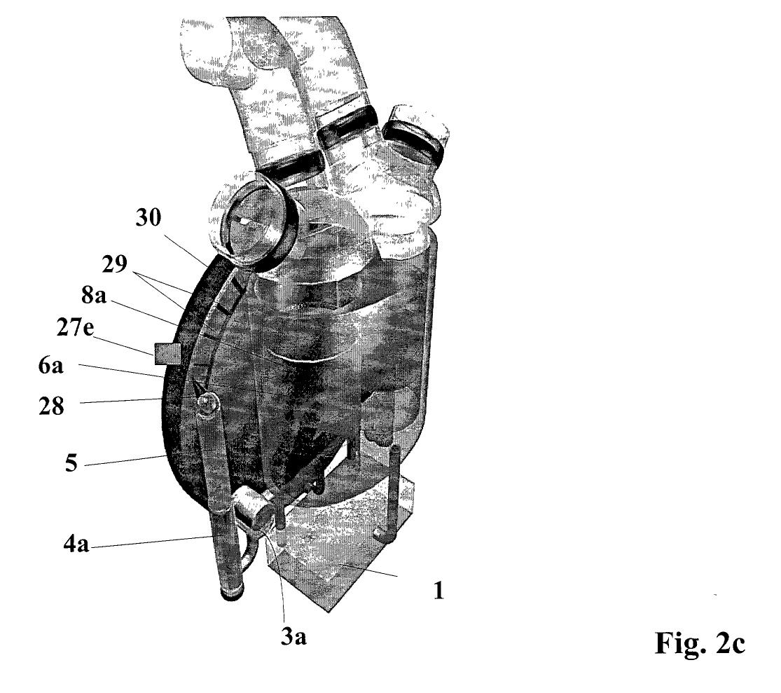

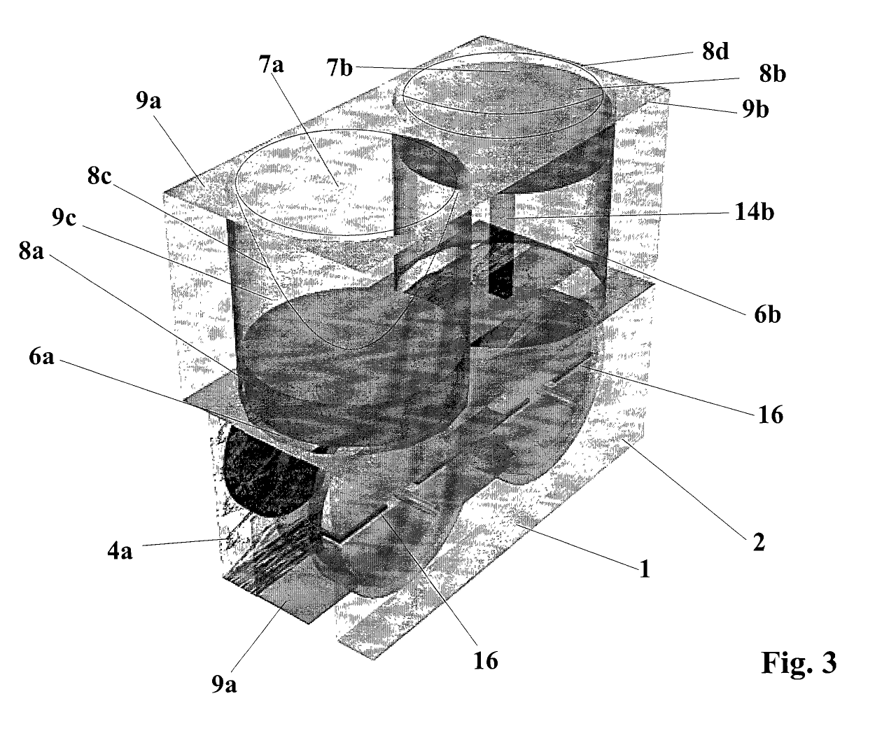

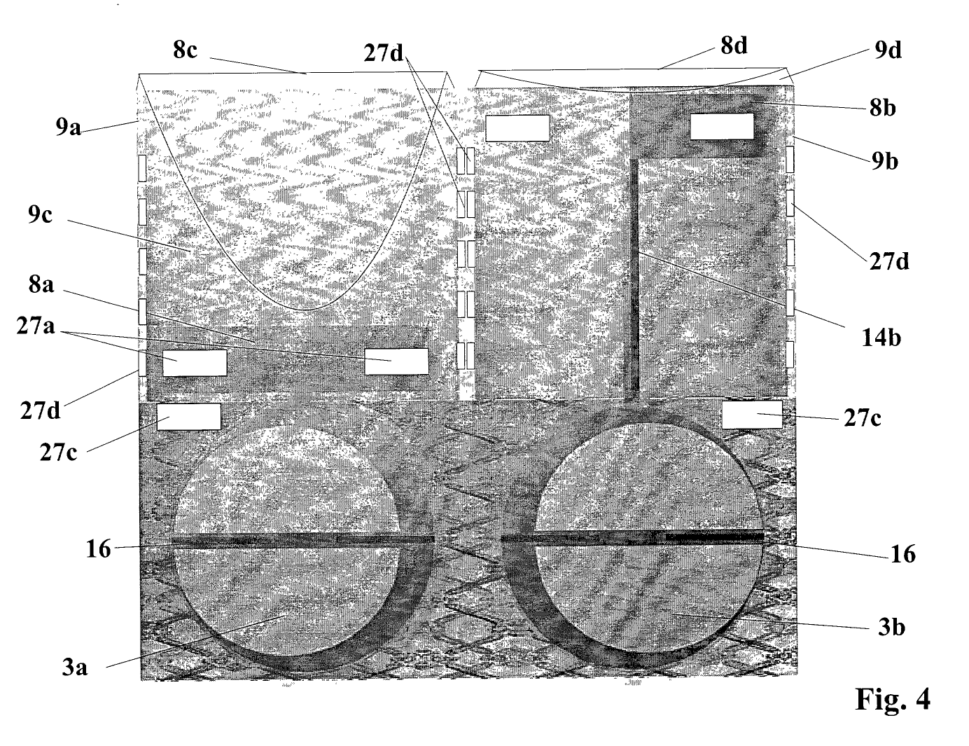

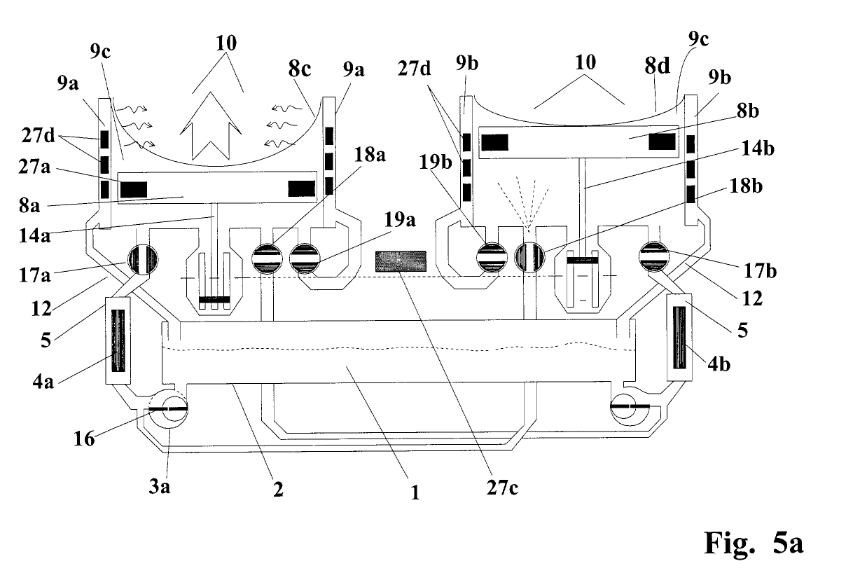

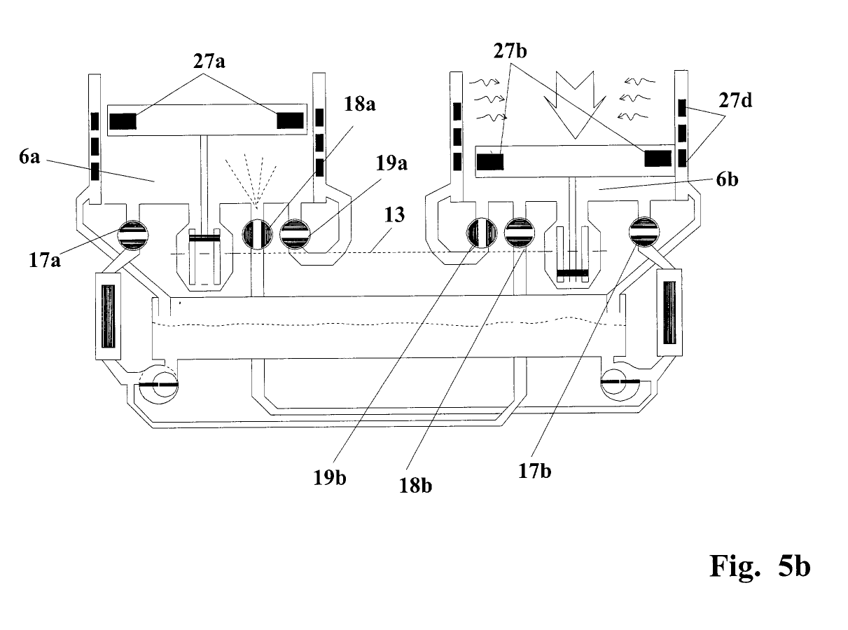

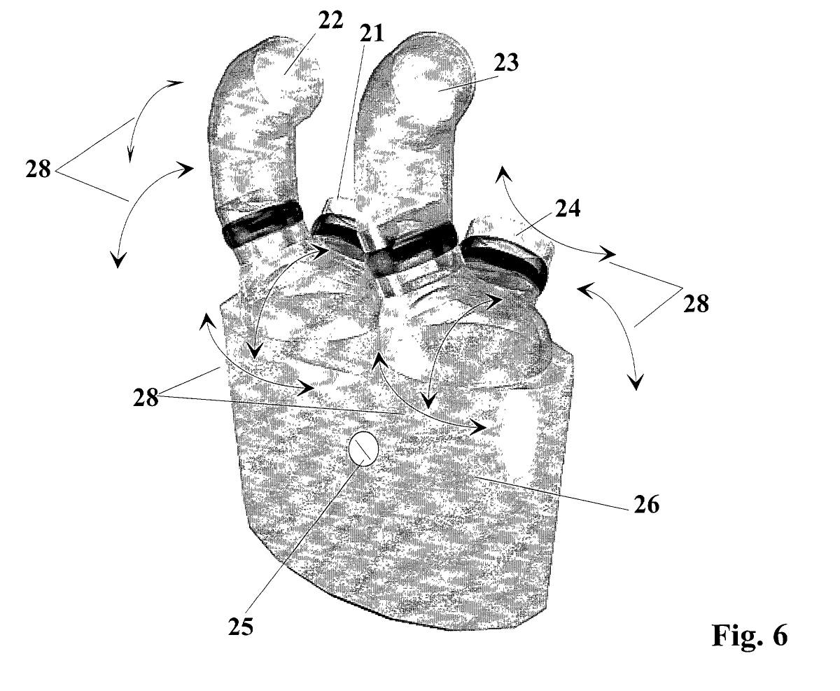

The working principle of AlphaCor is now described by utilizing the schematics and representations shown in FIGS. 1-6. The tandem thermodynamic cycle of AlphaCor is best described in FIG. 1, FIGS. 5a and 5b. In FIG. 1 the low vapor pressure fluid 1 is contained in tank 2. Tank 2 is hydraulically connected to redundant pumps 3a and 3b, to the decay heat alpha cartridges 4a and 4b where heat is transferred to said fluid 1. Said pumps 3a and 3b are high-pressure miniaturized positive displacement pumps. The exit of said alpha cartridges 4a and 4b are respectively connected to bottom ventricles 6a and 6b, to a cooling system 9a and 9b, whose cooling mechanism is formed by a convective fluid 9c and 9d trapped between the stretchable element or flexible membrane 8c and 8d and the pistons 8a and 8b. Said convective fluid 9c and 9d is characterized by a high vapor pressure and a high heat transfer convective coefficient and is in thermal contact with the surfaces 9a and 9b and the blood 10 through the stretchable element or flexible membrane 8c and 8d, but is not directly in contact with blood 10. The overall heat transfer cooling effect is indicated as number 11 in the cooling section of FIG. 1. In this representation blood 10 extract heat from the vapor after having expanded fluid 1 through a combined convective and conductive heat transfer mechanism 11. Therefore, said fluid 1, after condensing inside cooling elements 9a and 9b is discharged as condensed (sub-cooled liquid) fluid 1 back to tank 2 via hydraulic connections 12, so as to form a closed loop vapor cycle system. As shown in FIGS. 1, 2a, 2b, 2c, 5a and 5b, the fluid 1 is always in a sub-cooled liquid thermodynamic state inside the reservoir contained by tank 2. The tandem thermodynamic cycle operates as follows: Fluid 1 is pressurized through pumps 3a and 3b which are synchronized with respect to the position of pistons 8a and 8b, and also with respect to the positions of valves 17a, 17b, 18a, 18b, 19a, 19b, 20a, and 20b shown in FIGS. 5a and 5b. The synchronization is obtained by mechanically linking the opening of these valves to the position of blades 16 in pumps 3a, and 3b, to the crankshaft 13 whose connecting rods 14a and 14b are mechanically linked with a proper phase in accordance with the required pulsed flow of blood 10. 17a and 17b are high-pressure injection valves opening and closing according to the position of crankshaft 13 or via actuators controlled by controller 27c. Valves 18a and 18b are spray valves opening according to the position of crankshaft 13 or actuated by actuators controlled by controller 27c. Once fluid 1 is pressurized into the decay heat alpha cartridges 4a and 4b its thermodynamic state changes from liquid to superheated vapor, thereby increasing its pressure. Through valve 17a, or 17b, the vapor expands inside the bottom ventricles 6a, or 6b. The expansion of the vapor causes the pistons 8a or 8b to move (upward), thereby generating the power stroke. The pistons 8a and 8b are assembled inside piston cylinder assemblies forming two distinct hydraulic circuit: one connected to the bottom left or right ventricle 6a, or 6b, the “engine” side, the other connected to the vena cava 21, pulmonary trunk 22, pulmonary aorta 23, and aorta 24 as shown in FIG. 2a, the “blood” side. Once the vapor obtained from fluid 1 through alpha cartridges 4a and 4b expands in one of the two piston-cylinder assemblies it is simultaneously made to collapse in the other symmetrical piston-cylinder assembly. Collapsing said vapor is attained via injection of a minute amount of relatively cold fluid 1 through valve 18a, or 18b as shown in FIGS. 5a and 5b. Vapor collapsing can be seen as a sudden condensation which generates a vacuum in the bottom ventricles. When this phenomena occurs it causes the piston 8a (or 8b) to return to its bottom dead center, thereby provoking another power stroke while moving downward. In essence when one piston is executing a traditional power stroke due to vapor expansion, the other piston is also executing a power stroke in the opposite direction utilizing the vapor contraction instead of its expansion, thereby forming a tandem-thermodynamic cycle unlike traditional vapor cycles. When the piston 8a (or 8b) returns to its bottom dead center position it provokes a suction effects on the respective top ventricle 7a or 7b on the blood side. For example the action of suction executed by piston 8a on the blood side is synchronized with the action of compression executed by piston 8b also on the blood side. The synchronization is achieved through the connecting rods 14a and 14b to the common crankshaft 13. Once most of the vapor is collapsed inside one of the two piston-cylinder assemblies, another set of valves 19a and 19b (FIGS. 5a and 5b) allows the heated fluid (but still sub-cooled liquid) to enter a jacket-like heat exchanger 9a and 9b. Heat exchangers 9a and 9b are formed by chambers in thermal contact with the circulating blood 10 through a material 11 having the proper thermal conductivity and convectivity to assure minimum heating of blood 10 while providing enough cooling to the heated fluid 1 to return to the state of sub-cooled liquid. As mentioned, material 11 is formed by the combination of said convective fluid 9c and 9d, and the thermally conductive materials forming the stretchable element or flexible membrane 8c and 8d. In other words fluid 1, after passing through the decay heat alpha cartridges 4a or 4b, and after having expanded at the bottom of ventricle 6a (or 6b) needs to be cooled in order to return to its sub-cooled liquid state. This task is accomplished by letting the excess heat in fluid 1 to be transferred to the circulating blood 10. The heat exchanger 9a, and 9b and the choice of dimensions and physical properties of materials 11 have to be such that the increase in blood temperature does not exceed 1.5 Celsius degrees. In essence the blood 10 is the actual coolant of the tandem thermodynamic AlphaCor cycle. As soon as fluid 1 is fully condensed it returns to tank 2 which represents the “cold” thermal reservoir, thereby closing the closed loop tandem thermodynamic cycle. FIGS. 2a, 2b, and 2c show a preferential, but not limiting, representation of the internal components of AlphaCor. In fact the decay heat cartridges 4a and 4b can be positioned horizontally instead of vertically with respect to the ventricles and their shape can be of any geometry. As shown in these representations AlphaCor is essentially equipped with two symmetrical identical thermodynamic engines utilizing the same fluid 1 and the same cooling heat exchangers 9a and 9b. In FIG. 2c, the propulsion system is somewhat simplified by utilizing a turbine assembly 30 mechanically linked to crankshaft 13 and the connecting rods 14a and 14b. In this case the vapor collapsing effect is obtained at the exit of blades 29. For this turbine driven version of AlphaCor the high-pressure vapor obtained from the passage of fluid 1 through alpha cartridges 4a and 4b is regulated by nozzle 28 and expands through blades 29 of a turbine assembly contained inside casing 30 including bearings and mechanical support (not shown in this Figure). Casing 30 also contains the cooling chambers (not shown) executing the same purposes of chambers 9a and 9b described previously. Therefore, at the exit of blades 29 the vapor collapses trough minute injection of sub-cooled fluid 1 as described in FIGS. 5a and 5b by opening and closing valves 18a and 18b. Essentially in FIG. 2c the motion of the pistons is mainly dictated by the turbine system incased in casing 30. Variable heartbeat rate is achieved by automatically regulating the mass flow of fluid 1 through nozzle 28. In FIG. 3, AlphaCor is represented by a model in which the heat cartridges are not formed by concentric cylinders, as indicated in FIGS. 2a, 2b, and 2c. In FIG. 3 the decay heat cartridges 4a or 4b are formed by squared sections sandwiched and positioned essentially under and adjacent to the bottom left and right ventricles 6a and 6b respectively. In FIGS. 1, 2a, 2b, 2c, 5a, and 5b pumps 3a and 3b are outside tank 2, while in FIG. 3 and FIG. 4 they are submersed inside tank 2. Pumps 3a and 3b for all configurations are positive displacement pumps formed by blades 16 positioned in an eccentric rotor. However, other types of miniaturized positive displacement pumps, for example piston driven, would achieve the result of pressurizing fluid 1 into the decay heat alpha cartridges 4a and 4b. As described, decay heat alpha cartridges 4a and 4b are formed by alpha emitting materials embedded or deposited in/on a metal structure. This structure could reach up to 500 Celsius depending on the alpha emitting isotope chosen and the amount of such isotope. It is this thermal source the “heart” of the AlphaCor propulsion system. To protect and insulate the internal tissues surrounding the natural heart cavity from alpha radiation and from thermal heat, the decay heat alpha cartridges 4a and 4b can be positioned inside a jacketed structure 5. Structure 5 is therefore formed by a series of jackets whose inner jackets form the said annulus with vanes separating the alpha emitting surfaces as described previously, while the outermost jacket will have a forced vacuum executed during the manufacturing process. The high insulation formed by the vacuum minimizes heat transfer from the superheated fluid 1 and from the alpha cartridge surfaces to the surrounding environment. FIG. 6 shows a complete AlphaCor model equipped with a mechanical coupler 25 and a thermal and radiation shield 26. Thermal and radiation shield 26 is also formed by a jacked separated by a vacuum and acts as the outermost jacket 5 described. Its purpose is to further thermally insulate tissues and organs of the patient from the hot components inside AlphaCor. The rotating arrows 28 indicated in FIG. 6 serve the purpose of showing that the uppermost section of AlphaCor, on the blood side is flexible and can be made to rotate so as to position the various connectors 21, 22, 23, and 24 in the most favorable position to execute the transplant to the patient arteries and vena cava. Once AlphaCor is implanted in the patient the surgeon can execute a small tattoo in correspondence with the mechanical coupler 25. Through coupler 25, in case of malfunctioning of one of the two symmetric thermodynamic engines, it is possible to force a heartbeat rate through external mechanical means. Coupler 25 can be accessed by executing a minor incision whose position is indicated by the tattoo on the chest of the patient allowing the insertion of a special tool which would force a desired heartbeat while the surgeon can troubleshoot the device. The electric alternator formed by rare earth magnets 27a and 27b, its relative controller 27c, and the stationary coils 27d can be positioned in a manner that allows magnetic coupling with the movable pistons 8a and 8b. Furthermore, for the turbine configuration shown in FIG. 2c rare earth magnets can be embedded in blades 29 or positioned along the rotating components of the turbine while stationary coils 27e are magnetically coupled with said magnets and controlled by controller 27c. The electric alternator formed by rotating magnets (i.e. positioned on the rotor of turbine assembly 30 FIG. 2c), and that formed by magnets moving in a reciprocating manner (i.e. positioned on the pistons 8a and 8b), can also be coupled to produce electric energy. In general, said electric alternators are formed by rare earth magnets embedded in the pistons 8a and 8b and stationary coils 27d which produce alternate current with a frequency proportional to the heart beat rate. Controller 27c is formed by a computerized system based on a customized microchip which can be positioned anywhere in the AlphaCor system providing its sensors are exposed to the variables which will determine the heartbeat rate. Electric power for controller 27c is also provided by the electric alternators described. As mentioned the variables sampled by controller 27c can be represented by chemicals in the blood 10 stream, a pressure and frequency detector in the lungs or a combination of these. This concludes the description of AlphaCor and let's hope it can be quickly implemented and save as many lives as possible.

What is claimed is:

1. An autonomous miniaturized power plant configured to extract energy from the decay heat of alpha emitting isotopes, the system comprising:
At least one decay heat alpha cartridge for transferring said decay heat into a fluid;
At least one piston-cylinder assembly converting the expansion of a vapor obtained from said fluid into mechanical energy;
At least one high-pressure injection valve allowing said vapor to expand inside said piston-cylinder assembly;
At least one spray valve admitting said fluid in a sub-cooled liquid state inside said piston-cylinder assembly at the end of the positive power stroke so as to start contraction of said vapor;
At least one heat exchanger to condense said fluid.

2. An autonomous miniaturized power plant as defined in claim 1, wherein said decay heat alpha cartridge comprises:
At least one inlet hydraulically connected to said high-pressure injection valve wherein said fluid enters said alpha cartridge;
At least one outlet hydraulically connected to said piston-cylinder assembly;
At least one reinforced and sealed pellet shaped in any geometry and containing an amount of alpha emitting isotope in the form of deposited film, powder, or high pressure gas wherein said amount is proportional to the duration and thermal power required by the application;
At least one outer jacket containing a vacuum and thermally insulating said fluid and said alpha cartridges internal sealed pellets from the environment surrounding said alpha cartridge.

3. An autonomous miniaturized power plant as defined in claim 1, wherein said piston-cylinder assembly comprises;
At least one thermally and hydraulically insulating piston mechanically linked to a crankshaft;
At least one stationary coil;
Rare earth magnets magnetically coupled so as to form a magnetic path varying accordingly with the position of said insulating piston;
At least one electric alternator formed by said stationary coil and said rare earth magnets;
At least one controller circuit.

4. An autonomous miniaturized power plant as defined in claim 1, wherein said high-pressure injection valve is operated in a timely fashion in accordance with the position of said crankshaft and according to the processes forming a tandem thermodynamic cycle.

5. An autonomous miniaturized power plant as defined in claim 1, wherein said spray valve admitting said fluid in a sub-cooled liquid state inside said piston-cylinder assembly is operated in a timely fashion in accordance with the position of said crank-shaft and according to the processes forming a tandem thermodynamic cycle.

6. An autonomous miniaturized power plant as defined in claim 1, wherein said heat exchanger is formed by surfaces on one side in thermal contact with said fluid to condense said fluid, while on the other side said surfaces are in thermal contact with a convective fluid.

7. An autonomous miniaturized power plant as defined in claim 1, wherein said surfaces of said heat exchanger are on one side in thermal contact with said fluid to condense said fluid, while on the other side said surfaces are in contact with a cooling fluid.

8. An autonomous miniaturized power plant as defined in claim 1, wherein said condensed fluid flows and is stored in a tank hydraulically connected to at least one miniaturized high-pressure pump.

9. An autonomous miniaturized power plant as defined in claim 1, wherein said electric alternator provides electric power to power a computerized controller system.

10. An autonomous miniaturized power plant as defined in claim 1, wherein said electric alternator provides electric power to power all applications requiring compact and autonomous power sources for prolonged amounts of time.

11. An autonomous miniaturized power plant as defined in claim 1, wherein the movement of said piston is driven by the action of a turbine assembly.

12. An autonomous miniaturized power plant as defined in claim 1, wherein said rare earth magnets are assembled in the rotating components of said turbine assembly.

13. An autonomous miniaturized power plant as defined in claim 1, wherein said miniaturized power plant is utilized as a completely autonomous blood pumping device.

14. An autonomous miniaturized power plant as defined in claim 9, wherein said convective fluid is in thermal contact with a stretchable or flexible element separating blood from said convective fluid.

15. An autonomous miniaturized power plant as defined in claim 9, wherein said blood is said cooling fluid.

16. An autonomous miniaturized power plant as defined in claim 9, wherein said blood is pumped at a fixed rate.

17. An autonomous miniaturized power plant as defined in claim 9, wherein said blood is pumped at a variable rate.

18. An autonomous miniaturized power plant as defined in claim 9, wherein said blood is pumped at a variable rate by means of a computerized controller.

19. An autonomous miniaturized power plant as defined in claim 9, wherein said computerized controller monitors chemical in the blood stream and accordingly increases decreases said pumping rate.

20. An autonomous miniaturized power plant as defined in claim 9, wherein said computerized controller monitors pressure frequency in the lungs and accordingly regulates said pumping rate.

21. A method for producing power by a miniaturized power plant configured to extract energy from the decay heat of alpha emitting isotopes comprising:
At least one decay heat alpha cartridge for transferring said decay heat into a fluid;
At least one piston-cylinder assembly converting the expansion of a vapor obtained from said fluid into mechanical energy;
At least one high-pressure injection valve allowing said vapor to expand inside said piston-cylinder assembly;
At least one spray valve admitting said fluid in a sub-cooled liquid state inside said piston-cylinder assembly at the end of the positive power stroke so as to start contraction of said vapor;
At least one heat exchanger to condense said fluid;
At least one electric alternator converting said decay heat alpha cartridge thermal energy into electrical energy.

22. A method of producing pumping power by means of a miniaturized power plant configured to extract energy from decay heat of alpha emitting isotopes wherein blood is the coolant and comprising:
At least one decay heat alpha cartridge for transferring said decay heat into a fluid;
At least one piston-cylinder assembly converting the expansion of a vapor obtained from said fluid into mechanical energy;
At least one high-pressure injection valve allowing said vapor to expand inside said piston-cylinder assembly;
At least one spray valve admitting said fluid in a sub-cooled liquid state inside said piston-cylinder assembly at the end of the positive power stroke so as to start contraction of said vapor;
At least one heat exchanger to condense said fluid;
At least one electric alternator converting said decay heat alpha cartridge thermal energy into electrical energy;
